(19) United States
(12) Patent Application Publication
(10) Pub. No.: US 2017/0232526 A1
(43) Pub. Date: Aug. 17, 2017

(54) Ball Bearing Connector

(71) Applicant: Robert Cousineau, Ottawa (CA)

(72) Inventor: Robert Cousineau, Ottawa (CA)

(21) Appl. No.: 15/503,541

(22) PCT Filed: Aug. 14, 2015
(86) PCT No.: PCT/CA2015/050774

§ 371 Date: Feb. 13, 2017

Related U.S. Application Data
(60) Provisional application No. 62/037,590, filed on Aug. 14, 2014.

(51) Int. Cl. B23B 31/107; F16B 21/16

(52) U.S. Cl. CPC B23B 31/1071; F16B 21/165

(57) ABSTRACT

A ball bearing connector is provided, comprised of a setting tool further comprised of several steel balls which are biased either inwardly or outwardly by means of a biasing member. An easily interchangeable drill stop further comprised of an annular recession is position into or over the setting tool, and the balls located thereon fit in the annular recession to provide a releasable snap-fit connection between the drill stop and the setting tool.

### FIELD OF THE INVENTION

The invention relates to bearings and, more specifically, to a ball bearing snap-fit connector for use with setting tools.

### BACKGROUND

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the sleeve type variety, all of the above services and ceilings are suspended or secured.

Conventionally, a drill stop or a drill bit alone is utilized in order to create a bore hole. The drill stop or drill bit is removed from the bore hole, which is then cleaned of dust debris, and an anchor is deposited therein. Separately, a hand setting tool pin and sleigh hammer is then used to apply force into a bullet of the anchor in order to expand said anchor and set it within the concrete. Setting the anchor by hand with a setting pin and sledge hammer is very demanding, requiring the installer to hold the setting pin in place and also requiring said installer to use personal judgment in order to determine when the anchor is set depending on the amount of hits, the force applied per hit, etc.

It is a further problem in the art that the setting tool and drill stop are separate pieces of equipment, and typically need to be attachable one to the other to facilitate the setting of the anchor.

Inventors have attempted different ways in order to secure the setting tool to the drill bit or drill stop. For instance, U.S. Publication No. 2010/0303575 (Bland) discloses a drill bit and accompanying setting tool which is comprised of protrusions on the setting tool to fit into slots of the drill bit as specifically shown in FIG. 6. Unfortunately this type of system is more complicated to use, much more expensive to machine and the slots fill in with dust and other debris when being used, all of which contribute to wearing down the tool quickly.

Meanwhile, U.S. Pat. No. 7,065,855 (Janusz) discloses a setting tool which can be connected to a tool shaft by means of a ball bearing rather than a washer and regular bearing. The use of the ball bearing between the setting tool and the shaft, allows for the rotation of the setting tool independently of the shaft. Unfortunately, this system is not a snap fit connection between two members, Janusz uses the ball bearing connection in order to provide independent movement one part from the other. This adds to the amount of parts required and the complexity of the system, as a washer has to be inserted within an aperture, following by the bearings, followed by tool shaft, followed by another washer and a c-clamp.

U.S. Patent Publication No. 2011/0150590 (Buchner) discloses an installation system for ceiling mounted items. In this system, a tubular hollow extension is provided, mounted on a drill bit and has two ends. One end of the tube is connected to the drill bit while the opposite end can receive a suspension member to attached something thereto. In order to connect the tubular hollow extension to a drill bit, a securing sleeve is provided with a drill bit clamp to clamp onto the drill bit, and the tube is inserted within the extension and secured thereto by means of another clamp. While Buchner does disclose that either of the clamps (the first clamp holding the securing sleeve to the drill bit while the second clamp is holding the tube to the securing sleeve) can be replaced by “pins, screws, welded components, a ball bearing system or any other securing means known in the art”, Buchner fails to provide how this is achieved.

### SUMMARY OF THE INVENTION

In an aspect, the present invention provides a ball bearing connector comprising a setting tool for setting an anchor in cementitious materials which is further comprised of at least three balls and a biasing member to bias the at least three balls into corresponding openings. The ball bearing connector is also comprised of a drill stop releasably secured to the setting tool further comprised of an annular recession for receiving the at least three balls; wherein the at least three balls of the setting tool are snap-fit into the annular recession of the drill stop.

### BRIEF DESCRIPTION OF THE DRAWINGS

The following figures serve to illustrate various embodiments of features of the invention. These figures are illustrative and are not intended to be limiting.

FIG. 1 is a perspective view illustrative of a setting tool with ball bearings connecting into the annular recession of a drill stop according to a first embodiment of the present invention;

FIG. 1A is a front cross-sectional view of a setting tool according to a first embodiment of the present invention; and,

FIG. 2 is a perspective, partially cross-sectioned view illustrative of a setting tool with ball bearings connecting into the annular recession of a drill stop according to a second embodiment of the present invention;

FIG. 2A is an upper cross-sectional view illustrative of a setting tool according to a second embodiment of the present invention;

FIG. 2B is an enlarged, partially cross-sectioned view illustrative of the connection between the ball bearings of the setting tool and the annular recession of the drill stop according to a second embodiment of the present invention.

### DETAILED DESCRIPTION OF THE DRAWINGS

The following embodiments are merely illustrative and are not intended to be limiting. It will be appreciated that various modifications and/or alterations to the embodiments described herein may be made without departing from the invention and any modifications and/or alterations are within the scope of the contemplated invention.

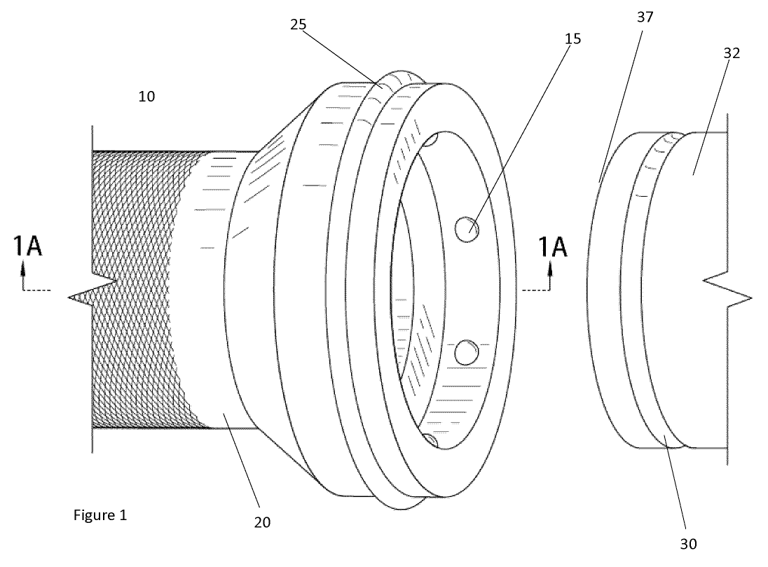

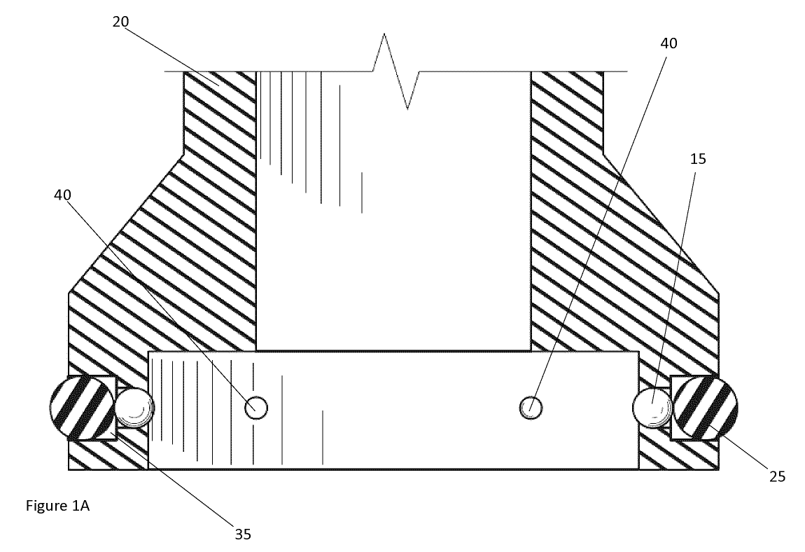

With reference to FIG. 1 and according to an embodiment of the present invention, a ball bearing connector 10 for setting an anchor (not shown) in cementitious materials is shown generally comprised of at least three balls 15 biased against at least three corresponding openings (not shown) of a setting tool 20 by means of a biasing member, generally referred to as an annular membrane 25. A worker skilled in the art would appreciate that the terms biasing member and annular membrane 25 can be used interchangeably. The openings (not shown) correspond in number to the amount of ball bearings 15 that are present in the ball bearing connector 10. The ball bearing connector 10 is further comprised of a drill stop 32 which is releasably secured to the setting tool 20, said drill stop 32 further comprised of an annular recession 30 for receiving the at least three balls 15. Therefore, the setting tool 20 can be snap-fit into the annular recession 30 of the drill stop 32 for the eventual setting of the anchor (not shown). The anchor is well known in the art and is set in a cementuous material in order to attach a fixture or other similar object thereto. In operation, when the setting tool 20 is positioned over the drill stop 32, the ball bearings 15 will first come into contact with an outer lip 37 of the drill stop 32. Said ball bearings 15 will then be pushed inward, and away from their respective openings (not shown), as the membrane 25 will allow the ball bearings 15 some margin to move outwards. Once the ball bearings 15 reach the annular recession 30 of the drill stop 32, the membrane 25 will still be biasing said ball bearings 15 forward and thus into the annular recession 30 to temporarily lock the setting tool 20 into the drill stop 32.

With reference to FIG. 1A and according to an embodiment of the present invention, a cross-sectional view of the setting tool 20 in FIG. 1 is shown. The annular membrane 25 is located on an outer periphery of the setting tool 20, in an annular groove 35 of said setting tool 20. As is shown, the membrane 25 exerts an inward force into the ball bearings 15, biasing said ball bearings 15 towards the opening 40, two of said openings 40 being shown therein.

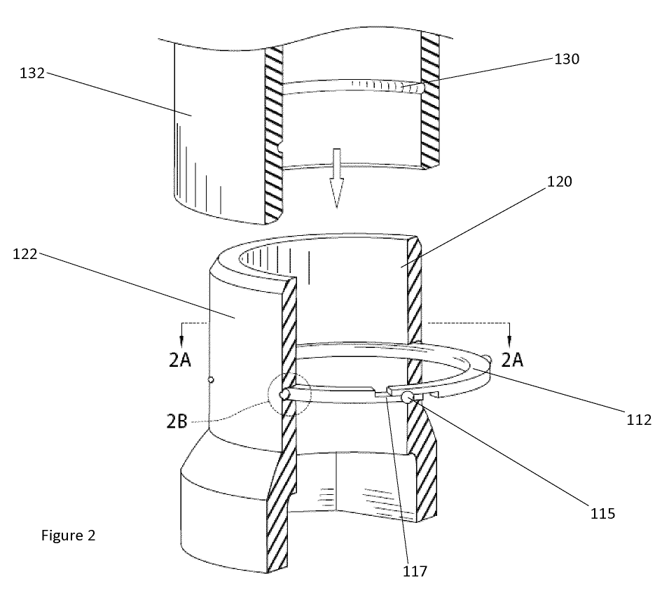

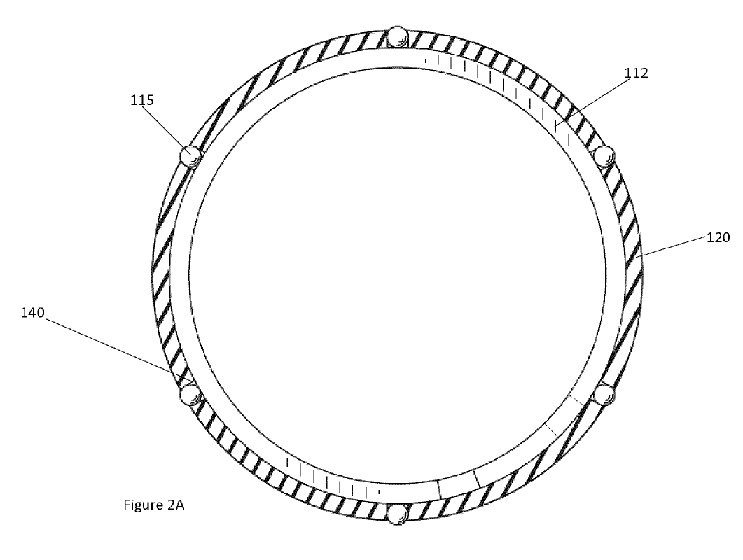

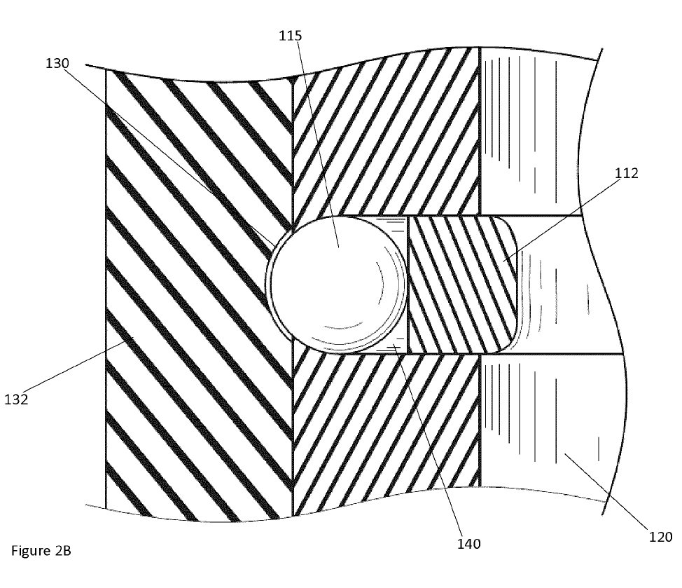

With reference to FIG. 2 and according to another embodiment of the present invention, a setting tool 120 for use with a ball bearing connector 10 is shown comprised of a biasing member, generally referred to as a compressible O-ring 112, secured within an annular groove (not shown) of the setting tool 120. A worker skilled in the art would appreciate that the terms biasing member and compressible O-ring 112 can be used interchangeably. The O-ring 112 is further comprised of a shiplap connection 117 whereby the O-ring 112 can only be compressed inwardly to a point when the shiplap connection 117 is flush with itself. Otherwise, the O-ring 112 serves to bias the balls 115 outwards, towards an outer surface 122 of the setting tool 120. To create the snap-fit connection, a drill stop 132 further comprised of an annular recession 130 is inserted over the setting tool 120. The relationship between the balls 115 and the annular recession 130 is the same as described above. Once the balls 115 reach the edge of the annular recession 130, the O-ring 112, biasing the balls 115 outwards will force said balls 115 into the annular recession 130 of the drill stop 132 and lock the setting tool 120 within said drill stop 132. A worker would simply need to forcibly disengage the setting tool 120 from the drill stop 132 by exerting the opposite force until the balls 115 are removed from the annular recession 130.

With reference to FIG. 2A and according to another embodiment of the present invention, the balls 115 are shown biased outwards by means of the O-ring 112. Openings (not shown) in the setting tool 120 are designed to keep the ball bearings 115 from protruding too far forward, sufficiently enough for said balls 115 to be able to snap into the annular recession (not shown).

With reference to FIGS. 2A and 2B and according to another embodiment of the present invention, a ball 115 is located within an opening 140 of the setting tool 120, biased outwardly towards an annular recession 130 of a drill stop 132 by means of an O-ring 112.

A worker skilled in the relevant art would appreciate that the ball bearing connection in this embodiment could be replaced by the ball bearing connection in the previously described embodiment. Indeed, the current embodiment could describe balls in respective opening and compressed inwardly by an annular membrane, while the previous embodiment could describe balls in openings biased outwardly by means of a compressible O-ring.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

What is claimed is:

1. A ball bearing connector comprising:
a. a setting tool for setting an anchor in cementitious materials further comprising:
i. at least three balls; and,
ii. a biasing member to bias the at least three balls into corresponding openings; and,
b. a drill stop releasably secured to the setting tool further comprised of an annular recession for receiving the at least three balls;
wherein the at least three balls of the setting tool are snap-fit into the annular recession of the drill stop.

2. The ball bearing connector of claim 1 wherein the biasing member is an annular membrane biasing the at least three balls inwardly.

3. The ball bearing connector of claim 1 wherein the biasing member is a compressible O-ring biasing the at least three balls outwardly.

4. The ball bearing connector of claim 3 wherein the O-ring is further comprised of a shiplap connection.
